(19) United States
(12) Patent Application Publication
(10) Pub. No.: US 2003/0115047 A1
(43) Pub. Date: Jun. 19, 2003

(54) Method and system for voice recognition in mobile communication systems

(75) Inventor: Fisseha Mekuria, Lund (SE)

Correspondence Address: Burns, Doane, Swecker & Mathis, L.L.P., P.O. Box 1404, Alexandria, VA, 22313-1404, US

(73) Assignee: Telefonaktiebolaget LM Ericsson (publ)

(21) Appl. No.: 10/359,613

(22) Filed: Feb. 7, 2003

Related U.S. Application Data
(63) Continuation of application No. 09/389,135, filed on Sep. 2, 1999.
(60) Provisional application No. 60/137,428, filed on Jun. 4, 1999.

(51) Int. Cl. G10L 19/10; G10L 19/08; G10L 19/04

(52) U.S. Cl. 704/219

(57) ABSTRACT

A system and method for recognizing the voice of a user of a communication is disclosed. Linear predictor coefficients are derived from digitized voice input, and the linear predictor coefficients are transformed to cepstrum coefficients representative of parameters of the user's voice. The cepstrum coefficients may be compared to stored coefficients representative of the users' voices to determine whether the user is a subscriber to one or more network services.

### RELATED APPLICATION

This application is related to, and claims priority from, U.S. Provisional Application Serial No. 60/137,428 entitled “METHOD AND SYSTEM FOR VOICE IDENTIFICATION IN MOBILE COMMUNICATION DEVICES” filed on Jun. 4, 1999, the disclosure of which is expressly incorporated herein by reference.

### BACKGROUND

The present invention generally relates to voice recognition in the field of communication systems and more particularly, to methods and systems for recognizing the voice of a particular user of a mobile communication devices.

The growth of commercial communication systems and, in particular, the explosive growth of cellular radiotelephone systems, has compelled system designers to search for ways to increase system capacity without reducing communication quality beyond consumer tolerance thresholds. One technique to achieve these objectives involved changing from systems wherein analog modulation was used to impress data onto a carrier wave, to systems wherein digital modulation was used to impress the data on carrier waves. Other attributes which are in great demand for radiocommunication devices include higher throughput rates and greater miniaturization of components and devices, particularly terminals (e.g., mobile phones) used in such systems.

As terminal devices get smaller, it becomes more difficult to implement a keypad solution for user input. Moreover, even in larger terminal devices, voice input may be a desirable feature to provide more ease-of-use to the man-machine interface. However, voice input creates several challenges for the terminal designer. One of those challenges is the ability to recognize, or identify, a particular user of a mobile communication device using parameters of the person's speech patterns, e.g., voice recognition. Today, many terminals require input of a personal identification number (PIN) via the keypad which is typically provided on the terminal. This PIN is then compared with a PIN stored in the terminal, e.g., in a SIM card. In the future, it would be desirable to authenticate a user's identity using his or her voice. Thus, instead of entering a PIN via the keyboard, the user would (after powering up the terminal) speak a predetermined word(s) or pattern(s) into the terminal's microphone as a form of voice PIN. Then, the terminal, or a separate network element in communication with the terminal, would analyze the predetermined word(s) or pattern(s) to determine if this user is authorized to use the terminal, or to access other network services.

Of course, voice recognition is not a simple task. Moreover, given potential memory and processing restrictions in terminal devices, it will be appreciated by those skilled in the art that analyzing the speech signal content and parameterizing the signal information into a compact parameter set suitable for differentiating between spoken words is an important and challenging task involved in creating a viable voice recognition algorithm. Compactness of the parameters (e.g., reference feature set) is a beneficial property of the feature extraction scheme and directly affects the memory requirement, and hence the vocabulary size, of any speech recognition system. While it is useful to remove redundant information from the input signal, it is also important to keep salient properties of the signal for robust recognition. Hence, a feature set should also carry enough information to be able to differentiate between voice patterns of different speakers in the presence of ambient noise.

Research has been ongoing in the area of voice/speech recognition for a number of years. An example of how voice recognition has been applied in radiocommunication systems can be found in U.S. Pat. No. 5,522,013, the disclosure of which is incorporated here by reference, which describes a speaker recognition technique that attempts to model an input speech sequence using a lossless tube as a proxy for a vocal tract. In this patent, a relationship is defined between PARCOR coefficients generated as a result of a linear predictive coding process and the areas of cylinder portions of the lossless tube model. However, among other drawbacks, the usage of LPC coefficients in this manner and the lossless tube mode requires a lot of memory to store feature sets associated with vocabulary words. Moreover, this model is believed to be adversely impacted by background noise which is commonly experienced in the types of terminal devices described above.

Other types of feature set extraction have been discussed. For example, the article entitled “Automatic Word Recognition in Cars”, IEEE Trans. On Speech & Audio Processing, Vol. 3, No. 5, September 1995, the disclosure of which is incorporated here by reference, describes a technique based on mel frequency cepstral coefficients of a voice signal which provides more robust and reliable reference feature sets for word recognition in noisy environments. Such cepstral feature sets are also insensitive to non-linear effects of the channel and model the phenomena of Lombard effect relative to than other feature set types, e.g., the LPC-based model of U.S. Pat. No. 5,522,013 described above. However, this particular type of mel frequency cepstral coefficient processing requires a significant amount of processing power, including a fast fourier transform and logarithmic processing, which renders it rather MIP intensive.

Accordingly, it would be desirable to create new techniques and systems for voice recognition which overcome the drawbacks of such conventional techniques.

### BRIEF DESCRIPTION OF THE DRAWINGS

These and other objects, features and advantages of the present invention will become more apparent upon reading from the following detailed description, taken in conjunction with the accompanying drawings, wherein:

FIG. 1 is a block diagram of an exemplary GSM communication system which advantageously uses the present invention;

FIG. 2 depicts a speech codec in a conventional GSM system;

FIG. 3 is a block diagram illustrating two methods of determining cepstral coefficients of a voice signal;

FIG. 4 is a block diagram illustrating a first exemplary embodiment of the present invention; and

FIG. 5 is a block diagram illustrating a second exemplary embodiment of the present invention.

### DETAILED DESCRIPTION

The following exemplary embodiments are provided in the context of time division multiple access (TDMA) radiocommunication systems. However, those skilled in the art will appreciate that a TDMA access methodology is used solely for the purposes of illustration, and that the present invention is readily applicable to all types of access methodologies including frequency division multiple access (FDMA), TDMA, code division multiple access (CDMA) and/or hybrids thereof.

Moreover, operation in accordance with the Global System for Mobile Communications (GSM) standard is described in European Telecommunication Standard Institute (ETSI) documents ETS 300 573, ETS 300 574, and ETS 300 578, which are hereby incorporated by reference. Therefore, the operation of an exemplary GSM system is only briefly described herein to the extent necessary for understanding the present invention. Although the present invention is described in terms of exemplary embodiments in a GSM system, those skilled in the art will appreciate that the present invention could be used in a wide variety of other digital communication systems, such as those based on PDC or D-AMPS standards and enhancements thereof.

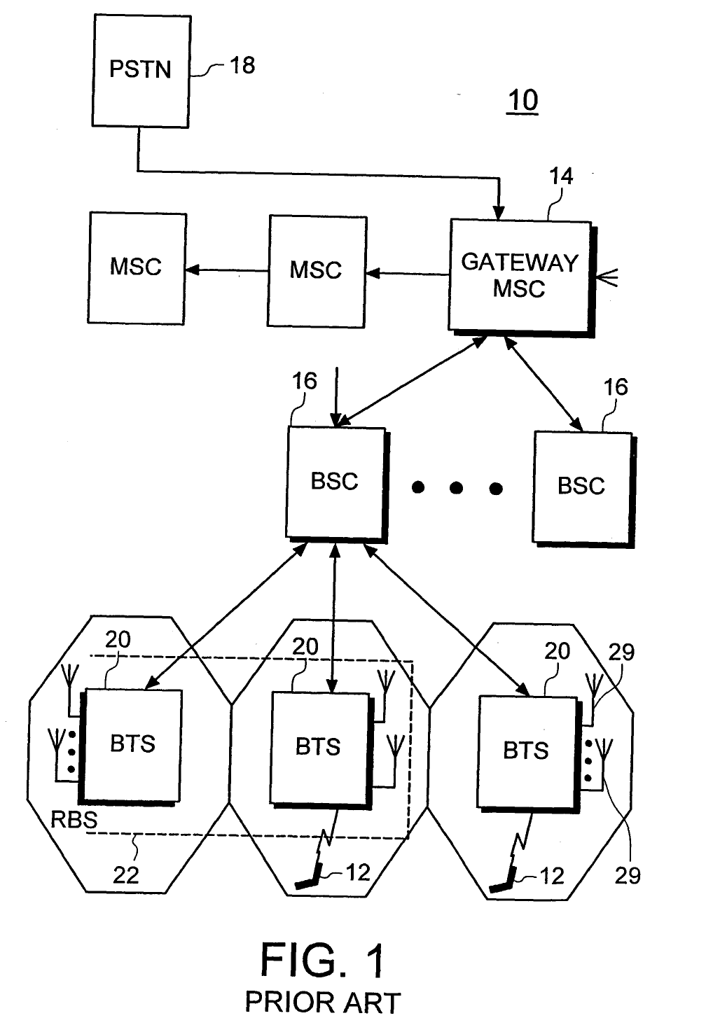

Referring to FIG. 1, a communication system 10 according to which the present invention can be implemented is depicted. The system 10 is designed as a hierarchical network with multiple levels for managing calls. Using a set of uplink and downlink frequencies, mobile stations 12 operating within the system 10 participate in calls using time slots allocated to them on these frequencies. At an upper hierarchical level, a group of Mobile Switching Centers (MSCs) 14 are responsible for the routing of calls from an originator to a destination. In particular, these entities are responsible for setup, control and termination of calls. One of the MSCs 14, commonly referred to as the gateway MSC, handles communication with a Public Switched Telephone Network (PSTN) 18, or other public and private networks.

At a lower hierarchical level, each of the MSCs 14 are connected to a group of base station controllers (BSCs) 16. Under the GSM standard, the BSC 16 communicates with a MSC 14 under a standard interface known as the A-interface, which is based on the Mobile Application Part of CCITT Signaling System No. 7.

At a still lower hierarchical level, each of the BSCs 16 controls a group of base transceiver stations (BTSs) 20. Each BTS 20 includes a number of transceivers (TRXs) (not shown) that use the uplink and downlink RF channels to serve a particular common geographical area, such as one or more communication cells 21. The BTSs 20 primarily provide the RF links for the transmission and reception of data bursts to and from the mobile stations 12 within their designated cell. In an exemplary embodiment, a number of BTSs 20 are incorporated into a radio base station (RBS) 22. The RBS 22 may be, for example, configured according to a family of RBS-2000 products, which products are offered by Telefonaktiebolaget L M Ericsson, the assignee of the present invention. For more details regarding exemplary mobile station 12 and RBS 22 implementations, the interested reader is referred to U.S. patent application Ser. No. 08/921,319, entitled “A Link Adaptation Method For Links using Modulation Schemes That Have Different Symbol Rates”, to Magnus Frodigh et al., and filed on Aug. 29, 1997, the disclosure of which is expressly incorporated here by reference.

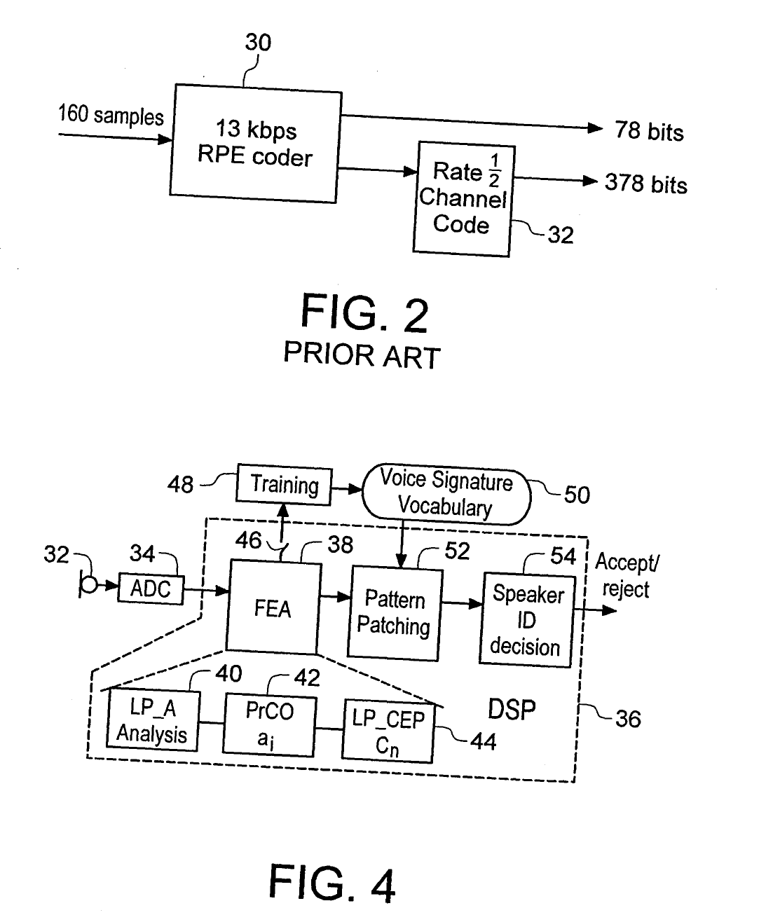

Speech coding (or more generally “source coding”) techniques are used to compress the information prior to transmission over the air interface, e.g., by mobile station 12, into a format which uses an acceptable amount of bandwidth but from which an intelligible output signal can be reproduced. Many different types of speech coding algorithms exist, e.g., residual excited linear predictive (RELP), regular-pulse excitation (RPE), etc., the details of which are not particularly relevant to this invention. FIG. 2 depicts a portion of the transmit signal processing path downstream of the A/D converter (not shown) which digitizes an exemplary input audio signal. A block of 160 speech samples is presented to an RPE speech coder 30 which operates in accordance with the well known GSM specifications (e.g., GSM 06.53) to produce two categories of output bits, 182 class 1 bits and 78 class 2 bits, for a total output bit rate of 13 kbps.

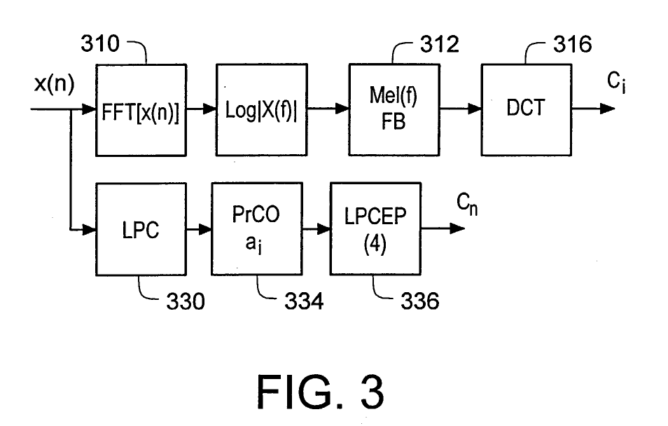

FIG. 3 is a schematic depiction of two methods of deriving cepstral coefficients from an input speech sample, or voice signal. The input voice signal is represented by an array of data points x(n). The first method shown in FIG. 3 is the fast fourier transform (FFT) based filter bank method. At step 310, the magnitude spectrum of an n point FFT is computed and, at step 312, the result is logarithmically distributed using the Mel frequency scale. An alternative to this which is very popular in feature extraction is the use of Mel-spectrum filterbank coefficients obtained by the frequency transformation of equation (1).

Mel(f)=2595.log₁₀(1+f/700) (1)

This may be followed by a step 316 which calculates discrete cosine transform DCT for the Mel-spectrum filter coefficients, which results in the cepstral coefficients Cᵢ of the input speech signal. Assuming that the Log filterbank amplitudes are given by an array Aᵢ, then the cepstral coefficients Cᵢ may be computed using equation (2). The Aᵢ may be obtained by multiplying each frequency bin by the filter bank gain and summing over each band. The cepstral coefficients Cᵢ obtained in this manner may be referred to as mel-frequency cepstral coefficients (MFCC).

$$Ci = \sqrt{\frac{2}{N}} {\sum }_{j = 1}^{N} {A}_{j} cos [ ( ( Π i / N ) ( j - 0.5 ) ) ] \qquad ( 2 )$$

FIG. 3 also illustrates a second method, in which, as part of the process of performing the speech coding depicted in FIG. 2 for information to be transmitted, the GSM speech coder in the mobile station 12 performs a linear predictive coding (LPC) process (as described above) which generates, as an interim parameter, linear predictor coefficients. More specifically, in step 330 the LPC process models the vocal tract as an all pole filter using the transfer function:

$$H ( z ) = \frac{1}{{\sum }_{i = 0}^{L} {a}_{i} {z}^{- i}} \qquad ( 3 )$$

In the foregoing equation, L is the order of the linear predictor, and {aᵢ,i=0,L} are the predictor (filter) coefficients (PrCO) with a₀=1. In a preferred embodiment of the invention, the all-pole filter coefficients are chosen for the LPC process to minimize the mean square filter prediction error (or residual signal) summed over the analysis window. The values of the predictor coefficients aᵢ can be calculated by using, for example, the well known Levinson-Durbin autocorrelation function (ACF) or a covariance method, the latter of which is used in GSM speech codecs.

At step 336, the prediction coefficients (PrCO) computed at step 334 by the speech coders in GSM can be utilized to obtain a cepstrum estimate for use in ASR algorithms. An efficient computation of the linear prediction cepstra (LPCEP in FIG. 1) may be performed done using the following recursive formula:

$${C}_{n} = - {a}_{n} + \frac{1}{n} {\sum }_{i = 1}^{n - 1} ( n - i ) {a}_{i} {C}_{n - i} \qquad ( 4 )$$

LPCEP feature extraction may be classified as a source based method due to the fact that the speech source (vocal tract) is modeled by the LP-Coefficients. The number of cepstral coefficients need not be equal to the number of predictor coefficients. The LP-cepstral coefficients are de-correlated and usually result in simpler implementation of the subsequent HMMs, since diagonal covariances can easily be computed for building the HMM word models.

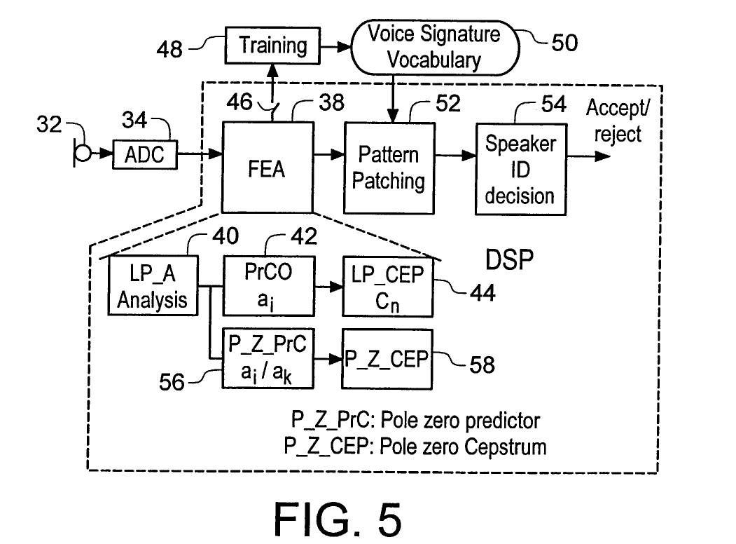

FIGS. 4-5 depict exemplary embodiments of a voice recognition system according to the present invention. It will be appreciated that the system depicted in FIGS. 4-5 is preferably embedded in appropriate logic circuitry in a mobile station (e.g., 12), but also may be embedded in a separate network element, for example a base station or a mobile switching center. Further, it will be appreciated that the mobile station (e.g. 12) will comprise circuitry for receiving speech input and encoding the speech input into signals suitable for transmission across an air interface. The particular details of the mobile station and/or the signal coding scheme (e.g., TDMA, FDMA, CDMA). are not critical to the present invention, and are not discussed at length herein. According to the invention, the prediction coefficients (PrCO) computed by the speech coders may be utilized to obtain a cepstrum estimate for use in voice/speech recognition algorithms. This has the advantages of low code memory requirement and utilization of existing algorithm blocks in mobiles stations. Referring now to FIG. 4, a signal is input through microphone 32 is digitized by A/D converter 34. The digital signal is then processed by, for example, a digital signal processor 36 to extract a feature set associated with the digitized speech in block 38. More specifically, the feature set may be extracted by first performing an LPC process (block 40) to obtain predictor coefficients aᵢ (block 42) in the manner described above, preferably using existing functionality in the speech codec associated with the terminal. Then, according to the present invention, these predictor coefficients aᵢ are transformed into cepstral coefficients at block 44. An efficient computation of the linear prediction cepstra cₙ (referred to as LP_CEP in FIGS. 3 and 4) from the LPC coefficients aᵢ generated by the speech codec can be accomplished using equation (4).

The system illustrated in FIG. 4 can be set to either a training mode, wherein switch 46 is closed, or a running mode, wherein switch 46 is opened. During training mode, the system can determine (block 48) and store (block 50) a set of LP_CEP coefficients which provide for accurate detection and identification of desired word(s) and/or pattern(s) for a particular user. During the running mode, a pattern matching unit 52 can compare a set of LP_CEP coefficients which have been extracted from an input word or speech patter from a particular user with a desired stored voice signature word or pattern retrieved from block 50. If the pattern matching unit 50 outputs a value which indicates a sufficiently close match, e.g., if a threshold minimum proximity distance is measured between the stored and extracted feature sets, then the speaker ID unit 54 can output a signal indicating that the user's identity has been verified. Otherwise, if the two don't correlate sufficiently, then a rejection signal can be output.

Another exemplary embodiment is illustrated in FIG. 5. Therein, functional blocks which are identical to those described above with respect to FIG. 4 are similarly numbered and a description thereof is not repeated here. However, in the exemplary embodiment of FIG. 5, the feature extraction unit 38 operates in a slightly different manner. In addition to using the LPC coefficients which are normally generated in a GSM speech codec, i.e., those associated with an all pole filter model of the vocal tract, the feature extraction unit 38 in FIG. 5 also extracts the zeros associated with the voice word(s) and/or pattern(s) being analyzed. This provides a more accurate model, i.e., by capturing the valleys as well as the peaks of the frequency spectrum associated with the input speech, which may be more important for voice recognition (input) than it is for speech coding (output).

Determining the zeros associated with the input speech word(s) or patterns can be accomplished as follows. First, the output of the LPC process block 40, which provides the predictor coefficients, is modified at block 56 to replace poles with an equivalent number of zeros by substituting aᵢ|aₖ for aᵢ. Then, the P_Z_CEP coefficients (all zero coefficients) are determined by using equation (2) above on the modified predictor coefficients at block 58. Thus, according to this exemplary embodiment, the feature set associated with a particular word or pattern is expanded to include more terms to improve the accuracy of the pattern matching during running mode and increase the likelihood that accurate voice recognition occurs.

Although the invention has been described in detail with reference only to a few exemplary embodiments, those skilled in the art will appreciate that various modifications can be made without departing from the invention. Accordingly, the invention is defined only by the following claims which are intended to embrace all equivalents thereof.

What is claimed is:

1. A method for matching a speech pattern comprising the steps of:
receiving a speech pattern from a user of a communication terminal;
performing a linear predictive coding (LPC) process on the speech pattern to generate predictor coefficients;
transforming the predictor coefficients into cepstrum coefficients; and
comparing the cepstrum coefficients with stored coefficients representative of a user's speech patterns.

2. The method of claim 1, wherein said step of transforming further comprises the step of:
determining predictor coefficients associated with both poles and zeros of a transfer function associated with a filter model representative of the user's speech pattern.

3. The method of claim 1, wherein said step of performing further comprises the step of:
reusing an LPC function associated with speech coding.

4. The method of claim 1, wherein said step of transforming further comprises the step of processing said predictor coefficients according to the following equation:
$${C}_{n} = - {a}_{n} + \frac{1}{n} {\sum }_{i = 1}^{n - 1} ( n - i ) {a}_{i} {C}_{n - i} \qquad ( 4 )$$

5. The method of claim 1, wherein said matching process is performed in a mobile communication terminal.

6. A method of generating reference parameters for identifying a user of a mobile communication terminal, comprising the steps of:
receiving, in an initialization step, a speech pattern from a user of a communication terminal;
performing a linear predictive coding (LPC) process on the speech pattern to generate predictor coefficients;
transforming the predictor coefficients into cepstrum coefficients; and
storing the cepstrum coefficients in a memory associated with the mobile communication device.

7. The method of claim 6, wherein said step of transforming further comprises the step of:
determining predictor coefficients associated with both poles and zeros of a transfer function associated with a filter model representative of the user's speech pattern.

8. The method of claim 6, further comprising, in a subsequent communication session, the steps of:
receiving a speech pattern from a user of the communication terminal;
performing a linear predictive coding (LPC) process on the speech pattern to generate predictor coefficients;
transforming the predictor coefficients into cepstrum coefficients; and
comparing the cepstrum coefficients with the cepstrum coefficients stored in the memory to identify the user of the communication device.

9. A mobile communication terminal, comprising:
means for receiving a speech pattern from a user of the communication terminal;
a linear predictive coding (LPC) module for processing the speech pattern to generate predictor coefficients;
a module for transforming the predictor coefficients into cepstrum coefficients; and
a comparator for comparing the cepstrum coefficients with cepstrum coefficients stored in a memory to identify the user of the communication device.

10. A mobile communication terminal, comprising:
means for receiving a speech pattern from a user of the communication terminal;
a linear predictive coding (LPC) module for processing the speech pattern to generate predictor coefficients;
a module for transforming the predictor coefficients into cepstrum coefficients; and
a memory for storing the cepstrum coefficients representative of the user's speech pattern.
